(19) United States
(12) Patent Application Publication
(10) Pub. No.: US 2025/0234008 A1
(43) Pub. Date: Jul. 17, 2025

(54) On Coefficient Value Prediction and Cost Definition

(71) Applicant: Bytedance Inc., Los Angeles, CA (US)

(72) Inventors: Mehdi Salehifar, San Diego, CA (US); Yuwen He, San Diego, CA (US); Kai Zhang, San Diego, CA (US); Li Zhang, San Diego, CA (US)

(21) Appl. No.: 19/169,832

(22) Filed: Apr. 3, 2025

Related U.S. Application Data
(63) Continuation of application No. PCT/US2023/034461, filed on Oct. 4, 2023.
(60) Provisional application No. 63/413,082, filed on Oct. 4, 2022.

(51) Int. Cl. H04N 19/14; H04N 19/70

(52) U.S. Cl. CPC H04N 19/14; H04N 19/70

(57) ABSTRACT

A mechanism for processing video data is disclosed. The mechanism determines to predict a value of a residual coefficient based on a cost. A conversion is performed between a visual media data and the media data file based on the residual coefficient. The coefficient may be used in transform coding or transform-skip coding.

### CROSS-REFERENCE TO RELATED PATENT APPLICATIONS

This application is a continuation of International Patent Application No. PCT/US2023/034461, filed on Oct. 4, 2023, which claims the priority to and benefits of U.S. Provisional Patent Application No. 63/413,082, filed on Oct. 4, 2022. The aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining to predict a value of a residual coefficient based on a cost; and performing a conversion between a visual media data and a bitstream based on the residual coefficient.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining to predict a value of a residual coefficient based on a cost; and generating a bitstream based on the determining.

A fifth aspect relates to a method for storing bitstream of a video comprising: determining to predict a value of a residual coefficient based on a cost; generating a bitstream based on the determining; and storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRA WINGS

For a more complete understanding of this disclosure, reference is now made to the following brief description, taken in connection with the accompanying drawings and detailed description, wherein like reference numerals represent like parts.

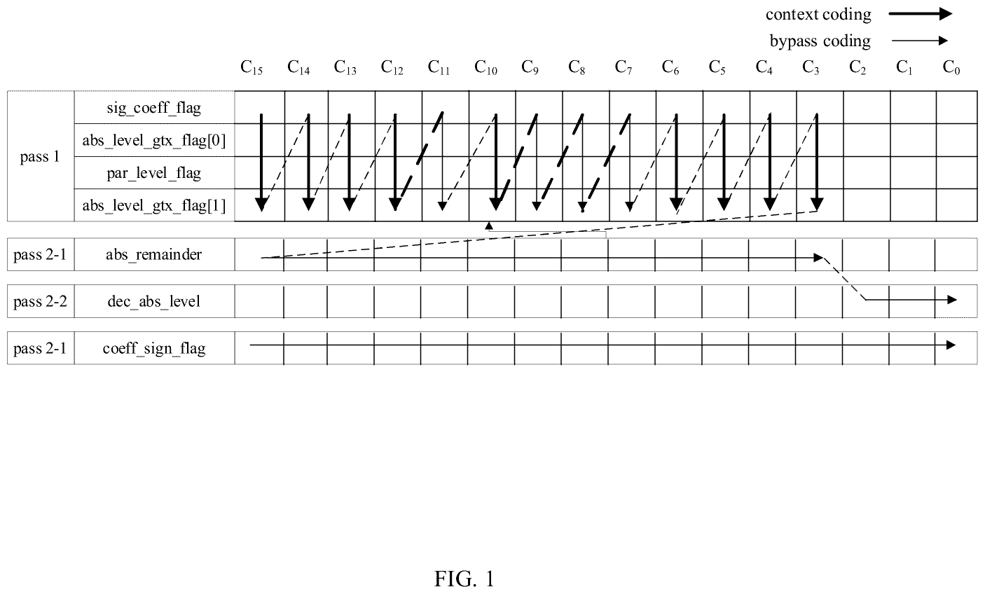

FIG. 1 is an example residual coding structure for transform blocks.

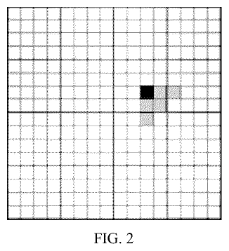

FIG. 2 is an example illustration of a template used for selecting probability models.

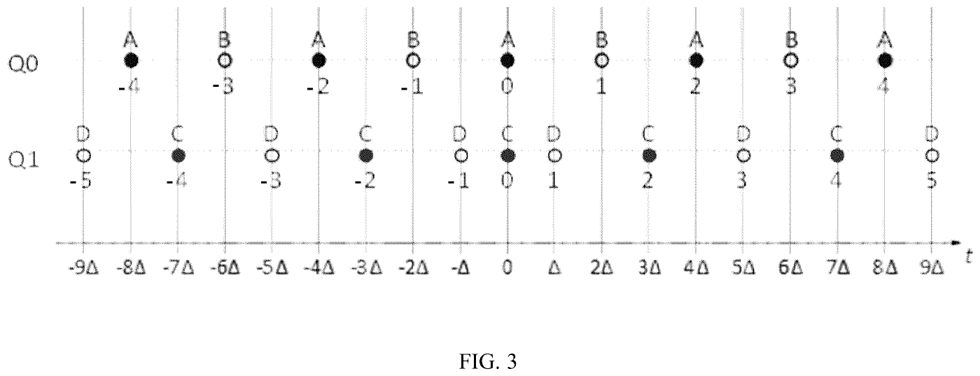

FIG. 3 is an example illustration of the two scalar quantizers used in an approach of dependent quantization.

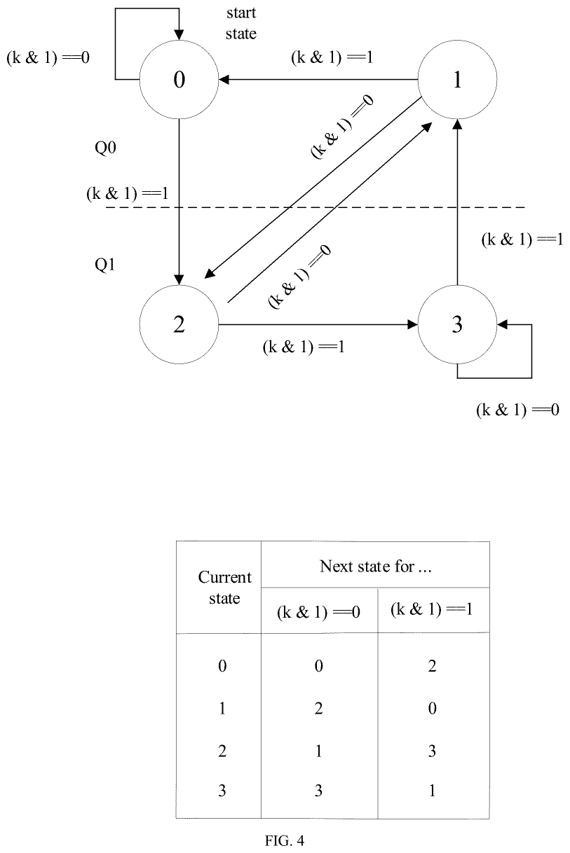

FIG. 4 is an example state transition and quantizer selection for a dependent quantization.

FIG. 5 is an example Low-Frequency Non-Separable Transform (LFNST) process.

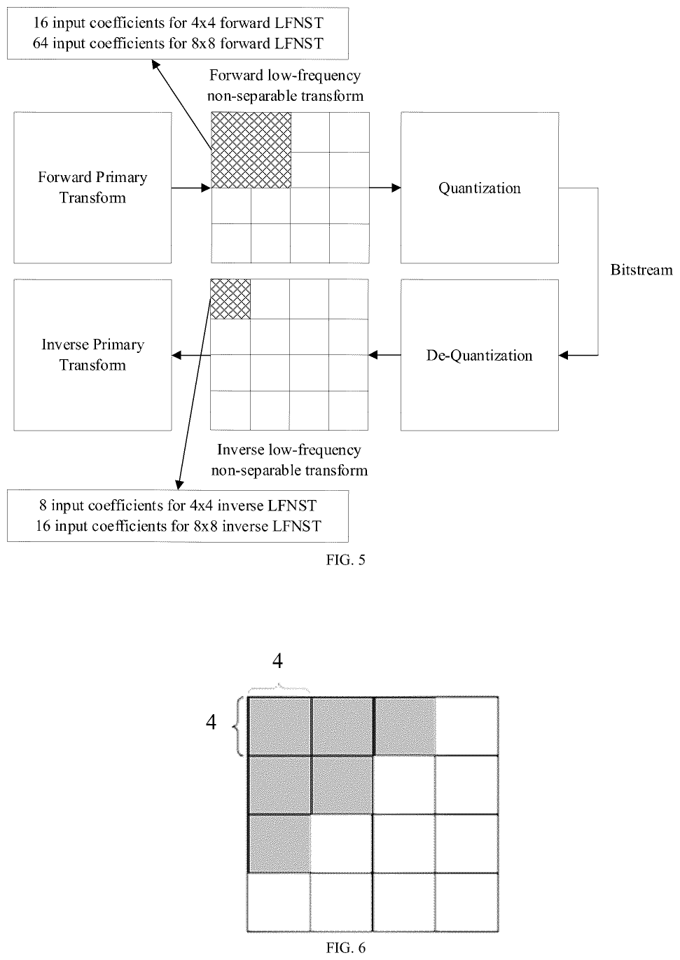

FIG. 6 is an example region of interest (ROI) for LFNST16.

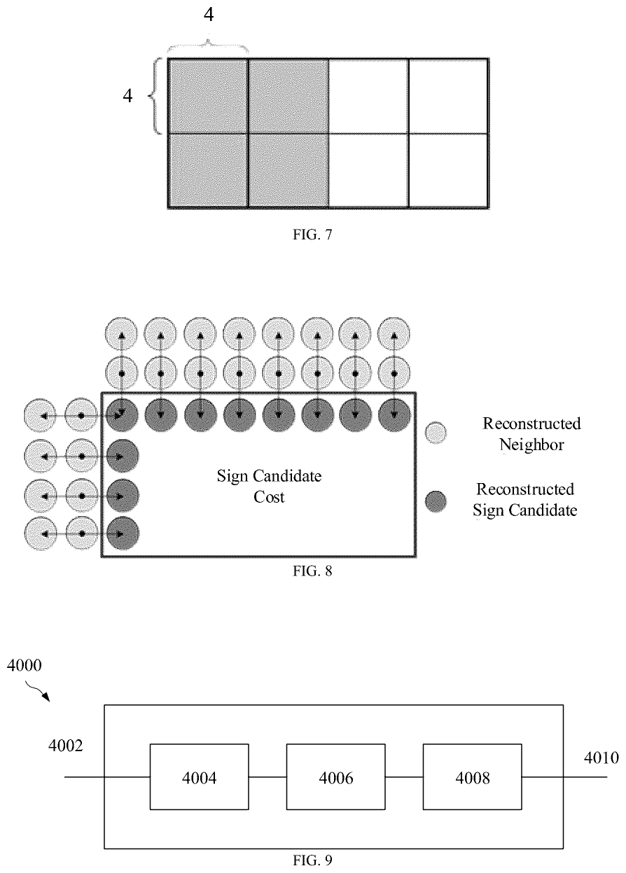

FIG. 7 is an example ROI for LFNST8.

FIG. 8 is an example discontinuity measure.

FIG. 9 is a block diagram showing an example video processing system.

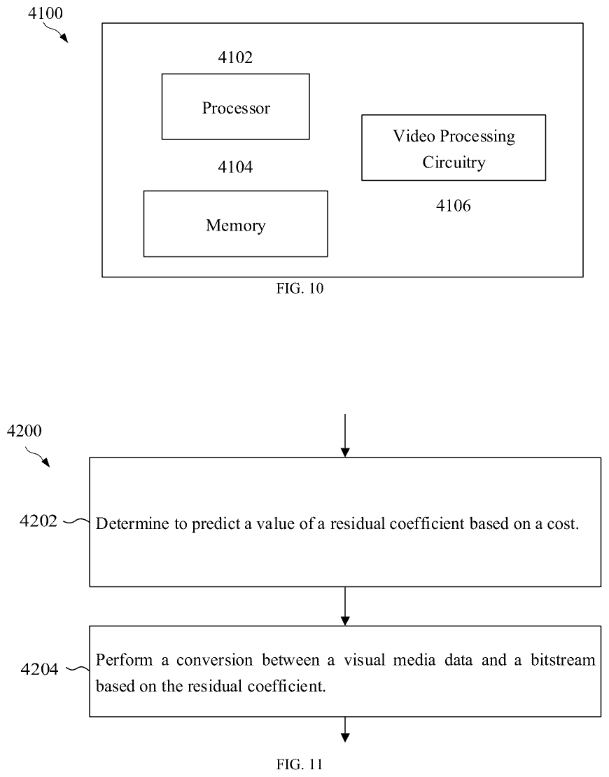

FIG. 10 is a block diagram of an example video processing apparatus.

FIG. 11 is a flowchart for an example method of video processing.

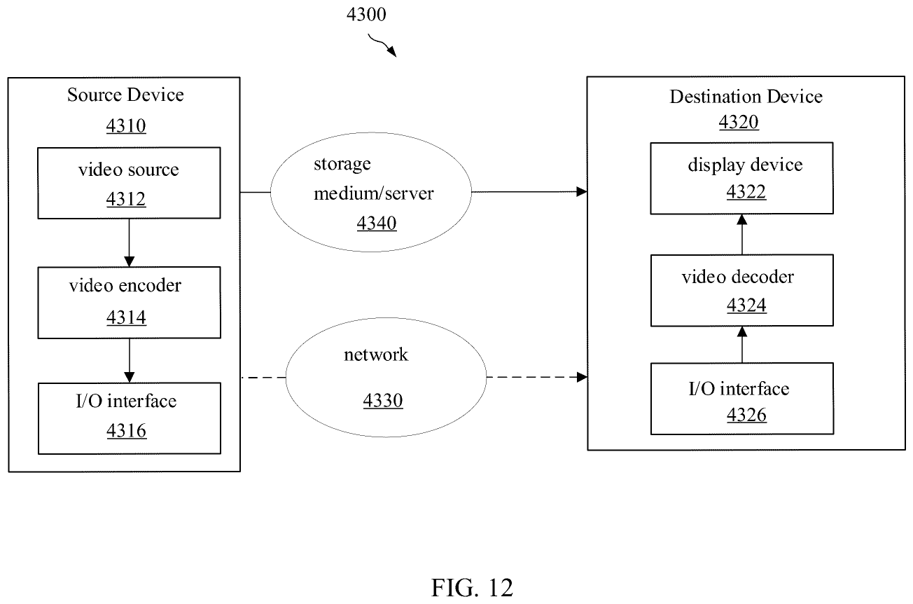

FIG. 12 is a block diagram that illustrates an example video coding system.

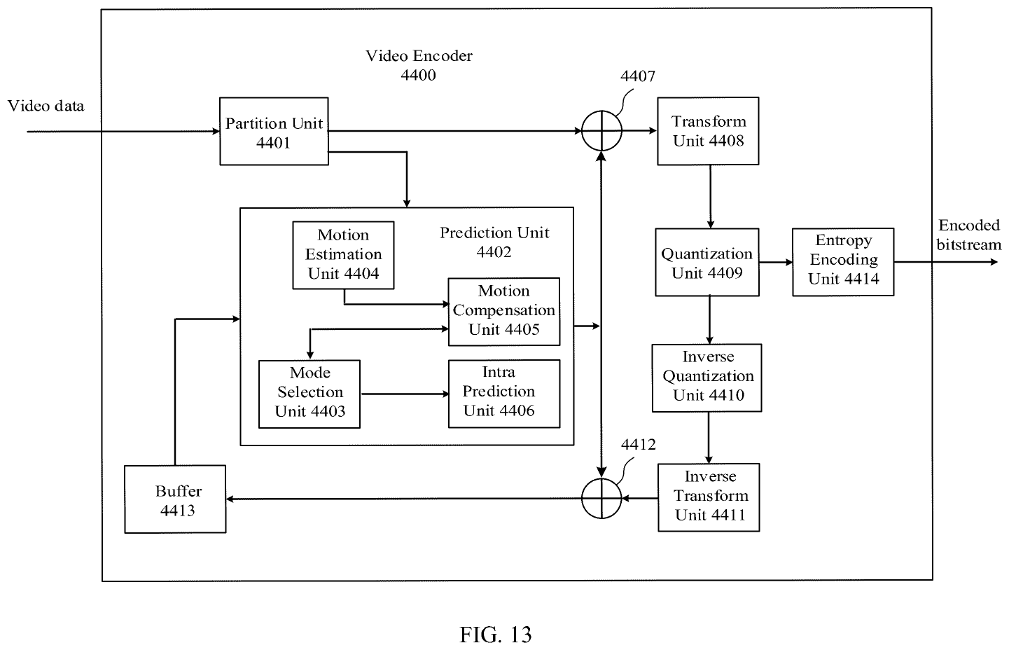

FIG. 13 is a block diagram that illustrates an example encoder.

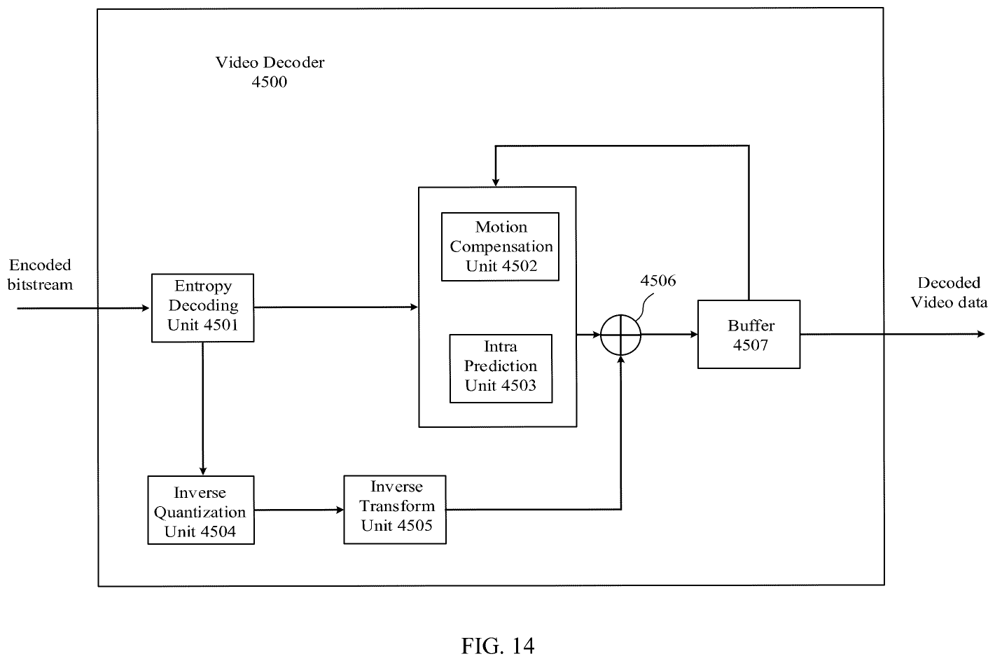

FIG. 14 is a block diagram that illustrates an example decoder.

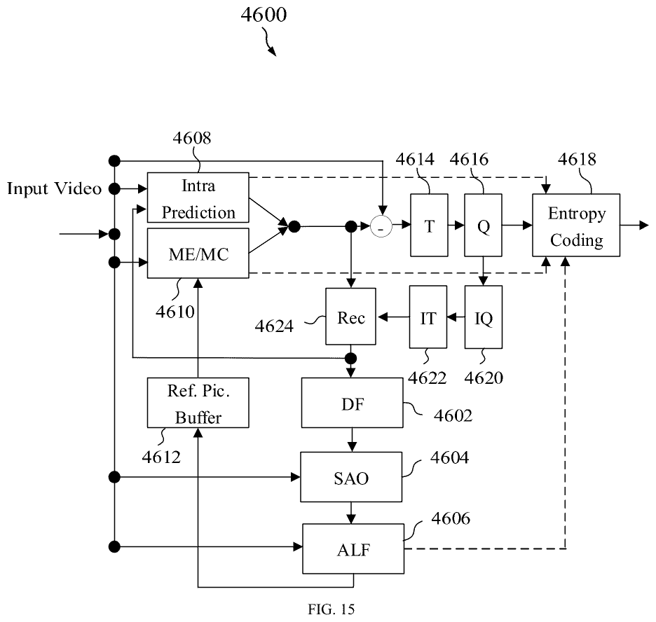

FIG. 15 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for ease of understanding and do not limit the applicability of techniques and embodiments disclosed in each section only to that section. Furthermore, H.266 terminology is used in some descriptions only for ease of understanding and not for limiting scope of the disclosed techniques. As such, the techniques described herein are applicable to other video codec protocols and designs also. In the present document, editing changes are shown to text by bold italics indicating cancelled text and bold underline indicating added text, with respect to a draft of the VVC specification.

### 1. Initial Discussion

This document is related to video and/or image coding technologies. Specifically, it is related to residual coding. The ideas may be applied individually or in various combinations, to video coding standard like High Efficiency Video Coding (HEVC), Versatile Video Coding (VVC), or the next generation video coding standards beyond VVC such as enhanced compression model (ECM) or future video coding standards or video codecs.

### 2. Video Coding Introduction

Video coding standards have evolved primarily through the development of the ITU-T and International Organization for Standardization (ISO)/International Electrotechnical Commission (IEC) standards. The International Telecommunication Union-Telecommunication Standardization Sector (ITU-T) produced H.261 and H.263, ISO/IEC produced Moving Picture Experts Group (MPEG)-1 and MPEG-4 Visual, and the two organizations jointly produced the H.262/MPEG-2 Video and H.264/MPEG-4 Advanced Video Coding (AVC) and H.265/High Efficiency Video Coding (HEVC) standards. Since H.262, the video coding standards are based on the hybrid video coding structure wherein temporal prediction plus transform coding are utilized. To explore video coding technologies beyond HEVC, Joint Video Exploration Team (JVET) was founded by video coding experts group (VCEG) and moving picture experts group (MPEG) jointly. This group finalized the Versatile Video Coding (VVC) [1] standard, aiming at yet another 50% bit-rate reduction and providing a range of additional functionalities. After finalizing VVC, activity for beyond VVC has started. A description of the additional tools on top of the VVC tools [2] has been summarized in [3], and the corresponding reference software is named as ECM.

An example reference software of VVC, is named VVC test model VTM. An example reference software of beyond VVC, is named ECM.

### 2.1 Transform Coefficient Level Coding

In HEVC, transform coefficients of a coding block are coded using non-overlapped coefficient groups (CGs), also known as subblocks, and each CG contains the coefficients of a 4×4 block of a coding block. In VVC, the selection of coefficient group sizes becomes dependent upon transform block (TB) size only, which removes the dependency on channel type. As a consequence, various CGs (1×16, 2×8, 8×2, 2×4, 4×2 and 16×1) become available. The CGs inside a coding block, and the transform coefficients within a CG, are coded according to pre-defined scan orders. To restrict the maximum number of context coded bins per pixel, the area of the TB and the color component are used to derive the maximum number of context-coded bins for a TB. For a luma TB, the maximum number of context-coded bins is equal to TB_zosize*1.75. For a chroma TB, the maximum number of context-coded bins (CCB) is equal to TB_zosize*1.25. Here, TB_zosize indicates the number of samples within a TB after coefficient zero-out. Note that the coded_sub_block_flag in transform skip residual mode is not considered for CCB count. Unlike HEVC, where residual coding is designed for the statistics and signal characteristics of transform coefficient levels, two separate residual coding structures are employed for transform coefficients and transform skip coefficients, respectively.

### 2.1.1 Residual Coding for Transform Coefficients

FIG. 1 is an example residual coding structure for transform blocks. In transform coefficient coding, a variable, remBinsPass1, is first set to the maximum number of context-coded bins and is decreased by one when a context-coded bin is signaled. While the remBinsPass1 is larger than or equal to four, the first coding pass, which includes the sig_coeff_flag, abs_level_gt1_flag, par_level_flag, and abs_level_gt3_flag, is coded by using context-coded bins. If the number of context coded bin is not greater than Mccb in the first pass coding, the rest part of level information, which is indicated to be further coded in the first pass, is coded with syntax element of abs_remainder by using Golomb-rice code and bypass-coded bins. When the remBinsPass1 becomes smaller than 4 while coding the first pass, the rest part of coefficients, which are indicated to be further coded in the first pass, are coded with a syntax element of abs_remainder, and coefficients which are not coded in the first pass is directly coded in the second pass with the syntax element of dec_abs_level by using Golomb-Rice code and bypass-coded bins as depicted in FIG. 1. The remBinsPass1 is reset for every TB. The transition of using context-coded bins for the sig_coeff_flag, abs_level_gt1_flag, par_level_flag, and abs_level_gt3_flag to using bypass-coded bins for the rest coefficients only happens at most once per TB. For a coefficient subblock, if the remBinsPass1 is smaller than 4, the entire coefficient subblock is coded by using bypass-coded bins. After all the above-mentioned level coding, the signs (sign_flag) for all scan positions with sig_coeff_flag equal to 1 is finally bypass coded. The unified (same) rice parameter (ricePar) derivation is used for Pass 2 and Pass 3. The only difference is that baseLevel is set to 4 and 0 for Pass 2 and Pass 3, respectively. Rice parameter is determined not only based on sum of absolute levels of neighboring five transform coefficients in local template, but the corresponding base level is also taken into consideration as follows:

$$RicePara = RiceParTable [ max ( min ( 31 , sumAbs - 5 * baseLevel ) , 0 ) ]$$

After the termination of the 1st subblock coding pass, the absolute value of each of the remaining yet-to-be-coded coefficients is coded by the syntax element dec_abs_level, which corresponds to a modified absolute level value with the zero-level value being conditionally mapped to a nonzero value. At the encoder side, the value of syntax element dec_abs_level is derived from the absolute level (absLevel), dependent quantizer state (QState) and the value of rice parameter (RicePara) as follows:

```
ZeroPos = ( QState < 2? 1 : 2 ) << RicePara
if (absLevel == 0)
  dec_abs_level = ZeroPos
else
  dec_abs_level = (absLevel <= ZeroPos) ? (absLevel − 1) : absLevel
```

### 2.1.2 Context Modeling for Coefficient Coding

The selection of probability models for the syntax elements related to absolute values of transform coefficient levels depends on the values of the absolute levels or partially reconstructed absolute levels in a local neighbourhood. FIG. 2 is an example illustration of a template used for selecting probability models. In FIG. 2, The black square specifies the current scan position, and the gray squares represent the local neighbourhood used.

The selected probability models depend on the sum of the absolute levels (or partially reconstructed absolute levels) in a local neighbourhood and the number of absolute levels greater than 0 (given by the number of sig_coeff_flags equal to 1) in the local neighbourhood. The context modelling and binarization depends on the following measures for the local neighbourhood:
numSig: the number of non-zero levels in the local neighbourhood;
sumAbs1: the sum of partially reconstructed absolute levels (absLevel1) after the first pass in the local neighbourhood;
sumAbs: the sum of reconstructed absolute levels in the local neighbourhood
diagonal position (d): the sum of the horizontal and vertical coordinates of a current scan position inside the transform block

Based on the values of numSig, sumAbs1, and d, the probability models for coding sig_flag, par_flag, gt1_flag, and gt2_flag are selected. The Rice parameter for binarizing abs_remainder is selected based on the values of sumAbs and numSig.

In VVC reduced 32-point MTS (RMTS32) based on skipping high frequency coefficients is used to reduce computational complexity of 32-point discrete sine transform (DST)-7/discrete cosine transform (DCT)-8. And it accompanies coefficient coding changes considering all types of zero-out (i.e., RMTS32 and the existing zero out for high frequency components in DCT2). Specifically, binarization of last non-zero coefficient position coding is coded based on reduced TU size, and the context model selection for the last non-zero coefficient position coding is determined by the original TU size. In addition, 60 context models are used to encode the sig_coeff_flag of transform coefficients. The selection of context model index is based on a sum of a maximum of five previously partially reconstructed absolute level called locSumAbsPass1 as follows:
If cIdx is equal to 0, ctxInc is derived as follows:

$$ctxInc = 12 * Max ( 0 , QState - 1 ) + Min ( ( locSumAbsPass 1 + 1 ) ≫ 1 , 3 ) + ( d < 2 ? 8 : ( d < 5 ? 4 : 0 ) )$$

Otherwise (cIdx is greater than 0), ctxInc is derived as follows:

$$ctxInc = 36 + 8 * Max ( 0 , QState - 1 ) + Min ( ( locSumAbsPass 1 + 1 ) ≫ 1 , 3 ) + ( d < 2 ? 4 : 0 )$$

### 2.2 Dependent Quantization

In addition, the same HEVC scalar quantization is used with a concept called dependent scalar quantization. FIG. 3 is an example illustration of the two scalar quantizers used in an approach of dependent quantization. Dependent scalar quantization refers to an approach in which the set of admissible reconstruction values for a transform coefficient depends on the values of the transform coefficient levels that precede the current transform coefficient level in reconstruction order. The main effect of this approach is that, in comparison to conventional independent scalar quantization as used in HEVC, the admissible reconstruction vectors are packed denser in the N-dimensional vector space (N represents the number of transform coefficients in a transform block). That means, for a given average number of admissible reconstruction vectors per N-dimensional unit volume, the average distortion between an input vector and the closest reconstruction vector is reduced. The approach of dependent scalar quantization is realized by: (a) defining two scalar quantizers with different reconstruction levels and (b) defining a process for switching between the two scalar quantizers.

The two scalar quantizers used, denoted by Q0 and Q1, are illustrated in FIG. 3. The location of the available reconstruction levels is uniquely specified by a quantization step size Δ. The scalar quantizer used (Q0 or Q1) is not explicitly signalled in the bitstream. Instead, the quantizer used for a current transform coefficient is determined by the parities of the transform coefficient levels that precede the current transform coefficient in coding/reconstruction order.

FIG. 4 is an example state transition and quantizer selection for a dependent quantization. As illustrated in FIG. 4, the switching between the two scalar quantizers (Q0 and Q1) is realized via a state machine with four states. The state can take four different values: 0, 1, 2, 3. It is uniquely determined by the parities of the transform coefficient levels preceding the current transform coefficient in coding/reconstruction order. At the start of the inverse quantization for a transform block, the state is set equal to 0. The transform coefficients are reconstructed in scanning order (e.g., in the same order they are entropy decoded). After a current transform coefficient is reconstructed, the state is updated as shown in FIG. 4, where k denotes the value of the transform coefficient level.

### 2.2.1 Dependent Quantization With 8-States

In ECM, coding efficiency of trellis-coded quantization in VVC is increased by increasing the number of quantization states (at the cost of a higher encoder complexity). Dependent quantization with 8 quantization states in addition to the variant of dependent quantization with 4 quantization state is supported (JVET-Q0243).

For supporting both variants of dependent quantization (4 and 8 states) in a unified framework, the decoding process for the VVC variant of dependent quantization is re-written.

The state transition table (sec. 7.4.12.11 in VVC) is modified from

$$QStateTransTable [ ] [ ] = \{ \{ 0 , 2 \} , \{ 2 , 0 \} , \{ 1 , 3 \} , \{ 3 , 1 \} \}$$

to

$$QStateTransTable [ ] [ ] = \{ \{ 0 , 1 \} , \{ 2 , 3 \} , \{ 1 , 0 \} , \{ 3 , 2 \} \}$$

There are three aspects that depend on the quantization state QState: (a) the mapping of transmitted transform coefficient levels to intermediate quantization indexes (part of the dequantization specified in the syntax); (b) the context selection for the sig_coeff_flag; (c) the derivation of the mapping parameter ZeroPos[] for transform coefficient levels coded in bypass mode. All three aspects are re-written in order to reflect the swapping of quantization states:
(a) The mapping of transmitted transform coefficient levels to intermediate quantization indexes (see syntax structure residual_coding() in VVC) is modified from

$$T r ansCoeffLevel [ x 0 ] [ y 0 ] [ cIdx ] [ xC ] [ y C ] = ( 2 * AbsLevel [ x C ] [ y C ] - ( QState > 1 ? 1 : 0 ) ) * ( 1 - 2 * coeff\_sign \_flag [ n ] )$$

to

$$TransCoeffLevel [ x 0 ] [ y 0 ] [ cIdx ] [ xC ] [ y C ] = ( 2 * AbsLevel [ x C ] [ y C ] - ( QState \& 1 ) ) * ( 1 - 2 * coeff\_sign \_flag [ n ] )$$

(b) The context selection of the sig_coeff_flag (see sec. 9.3.4.2.8 in VVC) depends on a parameter (context set id) that is derived based on the quantization state. In VVC, this parameter is given by
   Max (0, QState-1)
With the relabelling of the quantization states, this parameter can be derived according to
   ctxSetId[QState & 3] with ctxSetId[]={0, 1, 0, 2}
It should be noted that for the 4-state version, the result of (QState & 3) is equal to QState. The masking is only required for the 8-state version of dependent quantization.
   (c) The derivation of the mapping parameter ZeroPos[] for transform coefficient levels coded in bypass mode is modified from

$$Z e r o P o s [ n ] = ( QState < 2 ? 1 : 2 ) ≪ cRiceParam$$

to

$$Zero P o s [ n ] = ( 1 + ( QState \& 1 ) ) ≪ cRiceParam$$

### 2.3 Multiple Transform Selection (MTS) for Core Transform

In addition to DCT-II which has been employed in HEVC, a Multiple Transform Selection (MTS) scheme is used for residual coding both inter and intra coded blocks. MTS uses multiple selected transforms from the DCT8/DST7. The introduced transform matrices are DST-VII and DCT-VIII. Table I shows the basis functions of the selected DST/DCT.

TABLE I
Transform basis functions of DCT-II/VIII and DSTVII for N-point input

| Transform Type | Basis function Tᵢ(j), i, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | where, |
| | ${ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

In order to control MTS scheme, separate enabling flags are specified at SPS level for intra and inter, respectively. When MTS is enabled at SPS, a CU level flag is signaled to indicate whether MTS is applied or not. Here, MTS is applied only for luma. The MTS signaling is skipped when one of the below conditions is applied.
The position of the last significant coefficient for the luma TB is less than 1 (i.e., direct curren(DC) only)
The last significant coefficient of the luma TB is located inside the MTS zero-out region

If MTS CU flag is equal to zero, then DCT2 is applied in both directions. However, if MTS CU flag is equal to one, then two other flags are additionally signaled to indicate the transform type for the horizontal and vertical directions, respectively. Transform and signaling mapping table as shown in Table II. Unified the transform selection for intra-subblock partitioning (ISP) and implicit MTS is used by removing the intra-mode and block-shape dependencies. If current block is ISP mode or if the current block is intra block and both intra and inter explicit MTS is on, then only DST7 is used for both horizontal and vertical transform cores. When it comes to transform matrix precision, 8-bit primary transform cores are used. Therefore, all the transform cores used in HEVC are kept as the same, including 4-point DCT-2 and DST-7, 8-point, 16-point and 32-point DCT-2. Also, other transform cores including 64-point DCT-2, 4-point DCT-8, 8-point, 16-point, 32-point DST-7 and DCT-8, use 8-bit primary transform cores.

TABLE II
Transform and signaling mapping table

| MTS_CU_{—} | MTS_Hor_{—} | MTS_Ver_{—} | Intra/inter | |
|---|---|---|---|---|
| flag | flag | flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, High frequency transform coefficients are zeroed out for the DST-7 and DCT-8 blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST or Matrix-based Intra Prediction (MIP) is activated for the current CU. Also, the implicit MTS can be still enabled when MTS is enabled for inter coded blocks.

### 2.3.1 Enhanced MTS for Intra Coding

In the VVC design [1] for MTS, only DST7 and DCT8 transform kernels are utilized which are used for intra and inter coding.

Additional primary transforms including DCT5, DST4, DST1, and identity transform (IDT) are employed. Also, the MTS set is made dependent on the TU size and intra mode information. 16 different TU sizes are considered, and for each TU size 5 different classes are considered depending on intra-mode information. For each class, 1, 4 or 6 different transform pairs are considered. Number of intra MTS candidates are adaptively selected (between 1, 4 and 6 MTS candidates) depending on the sum of absolute value of transform coefficients. The sum is compared against the two fixed thresholds to determine the total number of allowed MTS candidates:
1 candidate: sum<=th0
4 candidates: th0<sum<=th 1
6 candidates: sum>th 1

Note, although a total of 80 different classes are considered, some of those different classes often share exactly same transform set. So there are 58 (less than 80) unique entries in the resultant look up table (LUT). For angular modes, a joint symmetry over TU shape and intra prediction is considered. So, a mode i (i>34) with TU shape A×B will be mapped to the same class corresponding to the mode j=(68−i) with TU shape B×A. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

### 2.4 Low-Frequency Non-Separable Transform (LFNST)

FIG. 5 is an example LFNST process. In VVC, LFNST is applied between forward primary transform and quantization (at encoder) and between de-quantization and inverse primary transform (at decoder side) as shown in FIG. 5. In LFNST, 4×4 non-separable transform or 8×8 non-separable transform is applied according to block size. For example, 4×4 LFNST is applied for small blocks (i.e., min(width, height)<8) and 8×8 LFNST is applied for larger blocks (i.e., min(width, height)>4).

Application of a non-separable transform, which is being used in LFNST, is described as follows using input as an example. To apply 4×4 LFNST, the 4×4 input block X

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ]$$

is first represented as a vector [symbol] :

$$\vec{X} = {[ {X}_{00} {X}_{01} {X}_{02} {X}_{03} {X}_{10} {X}_{11} {X}_{12} {X}_{13} {X}_{20} {X}_{21} {X}_{22} {X}_{23} {X}_{30} {X}_{31} {X}_{32} {X}_{33} ]}^{T}$$

The non-separable transform is calculated as [symbol] =T· [symbol] , where [symbol] indicates the transform coefficient vector, and T is a 16×16 transform matrix. The 16×1 coefficient vector [symbol] is subsequently re-organized as 4×4 block using the scanning order for that block (horizontal, vertical or diagonal). The coefficients with smaller index will be placed with the smaller scanning index in the 4×4 coefficient block.

### 2.4.1 Reduced Non-Separable Transform

LFNST (low-frequency non-separable transform) is based on direct matrix multiplication approach to apply non-separable transform so that it is implemented in a single pass without multiple iterations. However, the non-separable transform matrix dimension needs to be reduced to minimize computational complexity and memory space to store the transform coefficients. Hence, reduced non-separable transform (or reduced separable transform (RST)) method is used in LFNST. The main idea of the reduced non-separable transform is to map an N (N is commonly equal to 64 for 8×8 non-separable secondary transform (NSST)) dimensional vector to an R dimensional vector in a different space, where N/R(R<N) is the reduction factor. Hence, instead of N×N matrix, RST matrix becomes an R×N matrix as follows:

$${R}_{R \times N} = [ \begin{matrix}{t}_{11} & {t}_{12} & {t}_{13} & … & {t}_{1 N} \\ {t}_{21} & {t}_{22} & {t}_{23} & … & {t}_{2 N} \\ … & … & … & … & … \\ {t}_{R 1} & {t}_{R 2} & {t}_{R 3} & … & {t}_{R N}\end{matrix} ]$$

where the R rows of the transform are R bases of the N dimensional space. The inverse transform matrix for RT is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 kilobytes (KB) to 8 KB with reasonable performance drop. In order to reduce complexity LFNST is restricted to be applicable only if all coefficients outside the first coefficient sub-group are non-significant. Hence, all primary-only transform coefficients have to be zero when LFNST is applied. This allows a conditioning of the LFNST index signalling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8 when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

### 2.4.2 LFNST Extension With Large Kernel

The LFNST design in VVC is extended as follows:
The number of LFNST sets(S) and candidates (C) are extended to S=35 and C=3, and the LFNST set (IfnstTrSetIdx) for a given intra mode (predModeIntra) is derived according to the following formula:
   For predModeIntra<2, lfnstTrSetIdx is equal to 2
   lfnstTrSetIdx=predModeIntra, for predModeIntra in [0,34]
   lfnstTrSetIdx=68-predModeIntra, for predModeIntra in [35,66]
Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively.

The kernel dimensions are specified by:

$$( LFNST 4 , LFNST {8}^{*} , L F NST {16}^{*} ) = ( 16 \times 16 , 32 \times 64 , 32 \times 96 )$$

FIG. 6 is an example ROI for LFNST16. The forward LFNST is applied to top-left low frequency region, which is called ROI. When LFNST is applied, primary-transformed coefficients that exist in the region other than ROI are zeroed out, which is not changed from the VVC standard. The ROI for LFNST16 is depicted in FIG. 6. It comprises six 4×4 sub-blocks, which are consecutive in scan order. Since the number of input samples is 96, transform matrix for forward LFNST16 can be R×96. R is chosen to be 32 in this contribution, 32 coefficients (two 4×4 sub-blocks) are generated from forward LFNST16 accordingly, which are placed following coefficient scan order.

FIG. 7 is an example ROI for LFNST8. The forward LFNST8 matrix can be R×64 and R is chosen to be 32. The generated coefficients are located in the same manner as with LFNST16.

The mapping from intra prediction modes to these sets is shown in Table III,

TABLE III
Mapping of intra prediction modes to LFNST set index

| Intra pred. mode. | −14 | −13 | −12 | −11 | −10 | −9 | −8 | −7 | −6 | −5 | −4 | −3 | −2 | −1 | 0 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 0 |

| Intra pred. mode. | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| LFNST set index | 1 | 2 | 3 | 4 | 5 | 6 | 7 | 8 | 9 | 10 | 11 | 12 | 13 | 14 | 15 |
| Intra pred. mode. | 16 | 17 | 18 | 19 | 20 | 21 | 22 | 23 | 24 | 25 | 26 | 27 | 28 | 29 | 30 |
| LFNST set index | 16 | 17 | 18 | 19 | 20 | 21 | 22 | 23 | 24 | 25 | 26 | 27 | 28 | 29 | 30 |
| Intra pred. mode. | 31 | 32 | 33 | 34 | 35 | 36 | 37 | 38 | 39 | 40 | 41 | 42 | 43 | 44 | 45 |
| LFNST set index | 31 | 32 | 33 | 34 | 33 | 32 | 31 | 30 | 29 | 28 | 27 | 26 | 25 | 24 | 23 |
| Intra pred. mode. | 46 | 47 | 48 | 49 | 50 | 51 | 52 | 53 | 54 | 55 | 56 | 57 | 58 | 59 | 60 |
| LFNST set index | 22 | 21 | 20 | 19 | 18 | 17 | 16 | 15 | 14 | 13 | 12 | 11 | 10 | 9 | 8 |
| Intra pred. mode. | 61 | 62 | 63 | 64 | 65 | 66 | 67 | 68 | 69 | 70 | 71 | 72 | 73 | 74 | 75 |
| LFNST set index | 7 | 6 | 5 | 4 | 3 | 2 | 2 | 2 | 2 | 2 | 2 | 2 | 2 | 2 | 2 |

| Intra pred. mode. | 76 | 75 | 77 | 78 | 79 | 80 |
|---|---|---|---|---|---|---|
| LFNST set index | 2 | 2 | 2 | 2 | 2 | 2 |

### 2.5 Sign Prediction

The basic idea of the coefficient sign prediction method (JVET-D0031 and JVET-J0021) is to calculate reconstructed residual for both negative and positive sign combinations for applicable transform coefficients and select the hypothesis that minimizes a cost function.

FIG. 8 is an example discontinuity measure. To derive the best sign, the cost function is defined as discontinuity measure across block boundary shown on FIG. 8. It is measured for all hypotheses, and the one with the smallest cost is selected as a predictor for coefficient signs.

The cost function is defined as a sum of absolute second derivatives in the residual domain for the above row and left column as follows:

$$cost = {\sum }_{x = 0}^{w} \vert ( - {R}_{x , - 1} + 2 {R}_{x , 0} - {P}_{x 1} ) - {r}_{x , 1} \vert + {\sum }_{y = 0}^{h} \vert ( - {R}_{- 1 , y} + 2 {R}_{0 , y} - {P}_{1 , y} ) - {r}_{1 , y} \vert$$

where R is reconstructed neighbors, P is prediction of the current block, and r is the residual hypothesis. The term (−R₋₁+2R₀−P₁) can be calculated only once per block and only residual hypothesis is subtracted.

The transform coefficients with the largest K qIdx value of the top-left 4×4 area are selected. qIdx value is the transform coefficient level after compensating the impact from the multiple quantizers in DQ. A larger qIdx value will produce a larger de-quantized transform coefficient level. qIdx is derived as follows

$$qIdx = ( abs ( level ) ≪ 1 ) - ( state \& 1 ) ;$$

where level is the transform coefficient level parsed from the bitstream and state is a variable maintained by the encoder and decoder in DQ.

The sign prediction area was extended to maximum 32×32. Signs of top left M×N block are predicted. The value of M and N is computed as follows:
M=min (w, maxW)
N=min (h, maxH)
   where, w and h are the width and height of the transform block. The maximum area for sign prediction is not always set to 32×32. Encoder sets the maximum area (maxW, maxH) based on configuration, sequence class and QP, and signaled the area in SPS

The maximum number of predicted signs is kept unchanged. The sign prediction is also applied to LFNST blocks. And for LFNST block, a maximum of 4 coefficients in the top-left 4×4 area are allowed to be sign predicted.

### 3. Technical Problems Solved by Disclosed Technical Solutions

There are several parts in the residual coding/sign prediction may be improved. In some designs, there is no explicit prediction for the coefficient values. Further, in some designs the cost defined in the sign prediction does not use all the available information

### 4. A Listing of Solutions and Embodiments

To solve the above-described problem, methods as summarized below are disclosed. The items should be considered as examples to explain the general concepts and should not be interpreted in a narrow way. Furthermore, these examples can be applied individually or combined in any manner.

Examples 1-6 relate to Coefficient value prediction based on a cost.

### EXAMPLE 1

In an example, the value of the at least one residual coefficient may be predicted based on a cost.

The coefficient may be used in transform coding or transform-skip coding.

In one example only the value of the DC coefficient may be predicted.

In one example the value of the first N coefficient may be predicted. N may be any integer number such as 1, 2, 3, 10, 100 . . .

In one example the first N coefficient may be determined based on the raster scan order.

In one example the first N coefficient may be determined based on the diagonal scan order.

In one example the first N coefficient may be determined based on the vertical/horizontal scan order.

In one example the first N coefficient may be determined based on dividing the coefficient to subblocks and any combination of the scan order for the subblocks and any scan order for the coefficients inside of the subblocks.

In one example whether to and/or how to predict a coefficient may depend on coding information. The coding information may comprise: the partial value of the reconstructed coefficient; the parity; the surrounding neighboring values; the block size, e.g. CU, PU, TU sizes; the prediction mode used for that block, which may depend on whether the block is inter coded or intra coded, on the intra direction value, and/or on the type of the inter prediction used for that block; MTS index values; LFNST index values; block partitioning type; transform skip flag; quantization parameter (QP); and/or color components and/or color format.

In one example N coefficients at positions p1, p2 . . . pN may be predicted. For example, p1, . . . , pN may be any non-negative number such as 0, 3, 11, . . .

### EXAMPLE 2

In an example, information related to the coefficient value may be derived from the cost derivation process.

In one example the full coefficient may be derived from the process.

In one example a prediction of the coefficient may be derived from the process and coefficient may be added by this prediction to get the final one.

In one example a scaling factor may be derived from the process and coefficient may be multiplied/divided by this scaling factor to get the final one.

In one example the module T information may be derived, and final coefficient value may be T*coeff+t, where T may be any positive integer and t any integer between 0 and T-1. T may be 2, 3, 4, 10, . . . . Or any other positive integer. In one example T=2, and the process may determine the parity of the coefficient.

### EXAMPLE 3

In an example, the derived information related to prediction value may be from a set of values.

In one example it may predict the predication value from 2 fixed numbers: 0 and C; thus, the final coefficient value may be X or X+C, where X is the partially coded coefficient. In one example C may be any integer, such as −100, −10, 0, 3, 20, . . .

In one example it may always use the prediction without any signaling, thus depending on the predicting to 0 or C, final value may be X or X+C, where X is the partially coded coefficient.

In one example a flag may be coded to indicate whether the predication of 0/C was correct or not. If not the opposite (C/0 respectively) will be added to X.

In one example there may be M prediction value in one set, wherein M may be larger than one. M may be any positive integers such as 2, 3, 5, 10, . . .

In one example there may be more than one set let say N, where N could be any positive integer, and inside of each set there may be M_i candidates, for i from 1 to N. These N sets may be implicitly derived based on the surrounding information or may be signaled explicitly. M_i may be any positive integer.

In one example the M possible prediction value may be denoted as v1, . . . vM, and the best prediction denoted as vK (1<=K<=M), may be added to X, to create final coefficient of X+vK, without any signaling.

In one example all the M possible prediction may be sorted based on a predefined cost, and an index may be signaled to choose which one is the correct prediction.

In one example this prediction derivation process may be applied after dependent quantization (at both encoder and decoder) and/or RDOQ (at encoder only) has finished their jobs, or with their process simultaneously. In one example the predefined prediction values may not be constant.

In one example the predefined prediction values may be a function of the surrounding coefficient values. In one example a function of the summation of the absolute value of the T surrounding neighbors may determine the predefined prediction values. In one example a function of the summation of the partial absolute value of the T surrounding neighbors may determine the predefined prediction values.

### EXAMPLE 4

In an example, an actual prediction value may be used to code/decode the coefficient value remainder.

In one example an accurate prediction P may be derived on both encoder and decoder side. On encoder it codes X=coeff−P, and on decoder side it decodes X and add P to get the final coefficient value.

In one example this prediction derivation process may be applied after dependent quantization and/or RDOQ has finished their jobs.

In one example this prediction derivation process may be applied with the dependent quantization (DQ) and/or RDOQ process.

In one example an approximation of the prediction may be used. In one example abs value of the prediction may be limited to C, where C is any positive number such as 1, 2, 3, 4, . . . . In one example the parity of the prediction may be always even or odd or derived from the partial coefficient value.

In one example a binary search style method may be used to find the prediction value.

In one example all the possible value with abs values less than C, may be examined and the one with the lowest cost may be used as the prediction.

### EXAMPLE 5

In an example, a partial prediction value may be used to predict a part of the coefficient.

In one example, information related to being 0 or not may be predicted.

In one example, after signaling greater than 0 flag, the remaining may be predicted.

In one example information related to being greater than 1 or not may be predicted.

In one example, after signaling greater than 1 flag, the remaining may be predicted.

In one example information related to greater than 2 flag or not may be predicted.

In one example, after signaling greater than 2 flag, the remaining may be predicted.

In one example any information in pass 2 (as described in section 2.1.1) of residual coding may be predicted.

In one example, any information in pass 3 (as described in section 2.1.1) of residual coding may be predicted.

In one example, any parts of the coefficient may be signaled, and the other parts may be predicted.

In one example, this partial prediction may have any form such as, deriving prediction value from a set of values, or actual prediction for that part.

### EXAMPLE 6

In an example, the cost for evaluating a coefficient value hypothesis or prediction (as described in the section for sign prediction) may be a function of at least a neighboring sample.

For example, the cost may be calculated as the difference between the partial reconstruction of the border samples in the current block and corresponding reference. This corresponding reference may be derived from the neighboring block reconstruction. In one example, the partial reconstruction of the border samples and the corresponding reference may be adjacent. In one example, the partial reconstruction of the border samples and the corresponding reference have the same number of samples. And each reconstructed border sample has a corresponding reference sample. The difference can be calculated by comparing each pair of corresponding reconstructed border sample and reference sample.

In one example either one row or one column or both may be used as the partial reconstruction area.

In one example either K1 rows or K2 columns or both (K1 rows and K2 columns) may be used as the partial reconstruction area. K1 and K2 may be any integer number such as 1, 2, 3, . . .

In one example different cost functions may be used to derive one hypothesis cost. In one example this cost may be Sum of Absolute Difference (SAD) between the partial reconstruction and their references. In one example this cost may be Sum of Absolute Transformed Difference (SATD) or any other cost measure between the partial reconstruction and their references. In one example this cost may be Mean Removal based Sum of Absolute Difference (MR-SAD) between the template samples and their references. In one example this cost may be a weighted average of SAD/MR-SAD and SATD between the partial reconstruction and their references.

In one example, the cost function between partial reconstruction and reference template may be a Sum of absolute differences (SAD)/mean-removal (MR) SAD (MR-SAD); Sum of absolute transformed differences (SATD)/MR-SATD; Sum of squared differences (SSD)/MR-SSD; sum of square errors (SSE)/MR-SSE; Weighted SAD/weighted MR-SAD; Weighted SATD/weighted MR-SATD; Weighted SSD/weighted MR-SSD; Weighted SSE/weighted MR-SSE; and/or Gradient information.

The cost may consider the continuity (Boundary_SAD) between reference template and reconstructed samples adjacently or non-adjacently neighboring to current template in addition to the SAD calculated above. For example, reconstructed samples left and/or above adjacently or non-adjacently neighboring to current template are considered. In one example, the cost may be calculated based on SAD and Boundary_SAD. In one example, the cost may be calculated as (SAD+w*Boundary_SAD). w may be pre-defined or signaled or derived according to decoded information.

Example 7 relates to MTS set derivation.

### EXAMPLE 7

In an example, a number of the MTS candidates may depend on the coefficient characteristics.

In one example number of the MTS candidates may depend on the last significant coefficient position.

In one example number of the candidates for last significant coefficient position between P_i and P_i+1 may be K_i. P_i and K_i may be any non-negative numbers, where K_i<=K i+<=. . .

In one example number of the MTS candidates, and context for coding the index may depend on the sum of absolute value of the coefficients.

In one example number of the candidates for sum of absolute value of the coefficients between P_i and P_i+1 may be K_i. P_i and K_i may be any non-negative numbers, where K_i<=K_i+1<= . . .

In one example sum of absolute value of some of the positions (not all) may be used for determining number of the MTS candidates, and context for coding the index. In one example, DC position may not be used in the sum. In one example only coefficient at positions p1, p2 . . . pN may be used for the sum of absolute values. pi could be any non-negative integers.

In one example sum of absolute value of some of the positions (not all) may be used for determining number of the MTS candidates, and context for coding the index.

In one example number of the MTS candidates, and context for coding the index may depend on the sum of partial absolute value of the coefficients. In one example this partial sum may be min (abs(coeff), C), where C is a non-negative number such as 0, 2, 3, . . .

In one example any combination of the partial sum, and full sum depending on the coefficient position and/or value may be used for determining number of the MTS candidates, and/or context for coding the index.

In one example sum of the min (abs(coeff), Ci) may be used for determining number of the MTS candidates, and/or context for coding the index. Ci may any non-negative integer and may be different for each position pi. In the corner case of Ci=0, coefficient value at position pi is not used. In the corner case of Ci=MAX_INT, coefficient value at position pi is fully used.

In one example any other function beside min may be used.

Examples 8-11 relate to cost definition for sign prediction, coefficient value prediction, etc.

### EXAMPLE 8

In an example, the min function may be used to determine the predicted sign. In other words, if N signs are being predicted, there will be 2\hat{ }N hypothesis. Going through all the 2\hat{ }N costs and finding minimum may determine the predicted sign.

In one example the hypothesis with the lowest cost among all the 2\hat{ }N costs, may determine the predicted sign for all the N signs.

In another example the hypothesis with the lowest cost among all the 2\hat{ }N costs, may only determine the predicted sign for the first k signs. k maybe any integer number such as 1, 2, 3, till N.

In another example after coding to see whether the prediction of the first k signs is correct or not, the non-correct signs hypothesis may be thrown away, and the rest of the hypothesis may be used for predicting the remaining signs.

In one example any combination of the previous 2 approaches may be used to determine the predicted signs.

### EXAMPLE 9

In an example, a head-to-head min function may be used to determine the predicted signs.

In one example in this approach head-to-head min function may be defined as: after calculating the cost for the 2\hat{ }N hypothesis, for the ith sign, 2\hat{ }(N-1) hypothesis is related to Negative ith sign, and 2\hat{ }(N-1) hypothesis is related to Positive ith sign, and everything else (remaining N-1 sign situations) are identical. Then we may compare these 2\hat{ }(N-1) Negative and 2\hat{ }(N-1) Positive hypothesis head-to-head, and count number of the times Negative/Positive hypothesis has lower cost.

In one example whichever has the most head-to-head lower cost may be chosen as the predicted sign.

In one example we may apply these head-to-head min function on all the 2\hat{ }N hypothesis for all the signs.

In another example after knowing the actual sign for the ith sign, we may throw away the wrong hypothesis, and we apply this head-to-head min function on the remaining hypothesis.

In another example any combination of throwing out the wrong hypothesis/or keeping them may be used to determine the predicted signs.

### EXAMPLE 10

In an example, any combination of the different cost definitions may be used to determine the predicted signs.

In one example for signs at positions p1, . . . pJ one cost function may be used and for signs at positions q1, . . . qK another cost function may be used. p1, . . . , pJ and q1, . . . , qK may be any integer number between 1 and N and no 2 of them are the same. In one example one may use min function and another one head-to-head min function and vice versa.

In one example any combination of throwing out wrong hypothesis or keeping them may be used in combination with any combination of different cost function for each sign prediction.

In one example even for determining the sign prediction for one sign, different cost function may be used. In one example if based on one cost criteria Positive hypothesis and Negative hypothesis costs are smaller than a predefined threshold or bigger than a predefined threshold, the next cost function may be used to determine which sign to be predicted to. This may continue till the last cost functions in the queue, or till it satisfies the threshold criteria for that function. In one example a new cost may be defined based on the weighted cost difference between head-to-head hypotheses. In one example instead of just comparing the Positive hypothesis to Negative hypothesis and adding 1 or 0 to each camp, w1 and w2 may be added to each camp, where w1 and w2 may be any real number such as 0.3, 0.5, 1 . . .

### EXAMPLE 11

In an example, any cost definitions, decision making, . . . used for the sign prediction may be used for the coefficient value prediction too.

In one example min function may be used to determine the coefficient value prediction.

In another example head-to-head min function may be used to determine the coefficient value prediction.

In another example depending on coding side information related to the coefficient value prediction, wrong hypothesis may be thrown away.

In one example any combination of throwing out wrong hypothesis or keeping them may be used in combination with any combination of different cost function for each sign prediction.

Example 12 relates to sign prediction and coefficient value prediction candidates' selection

### EXAMPLE 12

In an example, any combination of sign prediction and coefficient value prediction for the candidates may be applied

In one example sign prediction may be applied on all the coefficients.

In another example sign prediction may be applied only on N signs.

In one example the first N signs based on a predefined scan order may be used for sign prediction.

In another example the first N signs based on coefficient magnitude may be used for the sign prediction.

In one example only the signs of the coefficient at positions p1, . . . pN may be used for sign prediction.

In one example only coefficient at positions q1, . . . qM may be used for coefficient value prediction.

In one example having sign prediction or coefficient value prediction may be applied mutually exclusive for a coefficient, i.e., if a coefficient sign has been predicted, its value would not and vice versa.

In one example having sign prediction or coefficient value prediction may be both applied for a coefficient.

In one example first all of the signs are predicted, then the coefficient values are predicted.

In another example first all of the coefficient values are predicted, then the signs are being predicted.

In another example any order combination of predicting the signs, and coefficient values may be applied.

Example 13 relates to residual coding passes.

### EXAMPLE 13

In an example, there may be differences on the process/passes (as described in section 2.1.1) used for residual coding.

In one example different passes depending on the total number of the context coded bin may be used.

In another example there may be no limitation on number of the context coded bin, thus there may not be different passes depending on the total number of the context coded bin used.

In one example there may be prediction for the position of the 0 or any other value.

In another example there may not be any special treatment for the 0 or any other value position.

Example 14-15 relates to general coding concepts.

### EXAMPLE 14

In an example, whether to and/or how to apply the methods described above may be dependent on coded information.

In one example, the coded information may include block sizes and/or temporal layers, and/or slice/picture types, colour component, et al.

### EXAMPLE 15

In an example, whether to and/or how to apply the methods described above may be indicated in the bitstream

The indication of enabling/disabling or which method to be applied may be signalled at sequence level, group of pictures level, picture level, slice level, and/or tile group level, such as in sequence header, picture header, sequence parameter set (SPS), video parameter set (VPS), decoding parameter set (DPS), decoding capability information (DCI), picture parameter set (PPS), adaptation parameter set (APS), slice header, and/or tile group header.

The indication of enabling/disabling or which method to be applied may be signaled at prediction block (PB), transform block (TB), coding block (CB), picture unit (PU), transform unit (TU), coding unit (CU), virtual pipeline data unit (VPDU), coding tree unit (CTU), CTU row, slice, tile, sub-picture, and/or other kinds of region contain more than one sample or pixel.

### 5. REFERENCES

[1] B. Bross, J. Chen, S. Liu, and Y.-K. Wang “Versatile Video Coding (Draft 10),” document JVET-S2001, 19th JVET meeting: by teleconference, 22 June-1 Jul. 2020.

[2] J. Chen, Y. Ye, S. Kim, “Algorithm descriptions for Versatile Video Coding and Test Model 11 (VTM 11)” document JVET-T2002, 20th JVET meeting by teleconference, 7-16 Oct. 2020.

[3] M. Coban, F. Léannec, K. Naser, and J. Strom “Algorithm description of Enhanced Compression Model 5 (ECM 5),” document JVET-Z2025, 26th JVET meeting: by teleconference, 20-29 Apr. 2022.

FIG. 9 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 10 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 11 is a flowchart for an example method 4200 of video processing. The method 4200 includes determining to predict a value of a residual coefficient based on a cost at step 4202. A conversion is performed between a visual media data and a bitstream based on the residual coefficient at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

FIG. 12 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVM) standard and other current and/or further standards.

FIG. 13 is a block diagram illustrating an example of video encoder 4400, which may be video encoder 4314 in the system 4300 illustrated in FIG. 12. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

FIG. 14 is a block diagram illustrating an example of video decoder 4500 which may be video decoder 4324 in the system 4300 illustrated in FIG. 12. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

FIG. 15 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.

1. A method for processing video data comprising: determining to predict a value of a residual coefficient based on a cost; and performing a conversion between a visual media data and a bitstream based on the residual coefficient.

2. The method of claim 1, wherein the coefficient is used in transform coding or transform-skip coding.

3. The method of any of claims 1-2, wherein only a DC coefficient value is predicted.

4. The method of any of claims 1-3, wherein the value of the first N coefficients are predicted, and wherein the first N coefficients are determined based on raster scan order, diagonal scan order, or based on dividing the coefficients into subblocks and based on any combination of the scan order for the subblocks and any scan order for the coefficients inside of the subblocks.

5. The method of any of claims 1-4, wherein prediction of a coefficient depends on coding information comprising a partial value of the reconstructed coefficient; a parity; surrounding neighboring values; a block size, CU, PU, or TU sizes; a prediction mode used for that block, which may depend on whether the block is inter coded or intra coded, on the intra direction value, or on the type of the inter prediction used for that block; MTS index values; LFNST index values; block partitioning type; transform skip flag; quantization parameter (QP); color components, or color format.

6. The method of any of claims 1-5, wherein N coefficients at positions p1, p2 . . . pN are predicted.

7. The method of any of claims 1-6, wherein information related to a coefficient value is derived from a cost derivation process.

8. The method of any of claims 1-7, wherein a full coefficient may be derived from the process, a prediction of the coefficient is derived from the process and a coefficient is added by the prediction to obtain a final coefficient, a scaling factor is derived from the process and a coefficient is computed based on the scaling factor, or module T information is derived and a final coefficient value is T*coeff+t, where T may be any positive integer and t any integer between 0 and T-1.

9. The method of any of claims 1-8, wherein information related to prediction value is derived from a set of values.

10. The method of any of claims 1-9, wherein the prediction value is predicted from a plurality of fixed numbers, or wherein the prediction value is not signaled, or wherein a flag is coded to indicate whether a predication is correct, or wherein M prediction values are included in one set, or wherein the information is related to N sets of values that include M_i candidates, for i from 1 to N and the N sets are implicitly derived or signalled explicitly, or wherein M possible prediction values are denoted as v1, . . . vM, and a best prediction denoted as vK (1<=K<=M), is added to X, to create final coefficient of X+vK, without any signaling, or all M possible prediction are sorted based on a predefined cost, and an index is signaled to indicate a correct prediction, or wherein a prediction derivation process is applied after dependent quantization or rate distortion optimization quantization is complete, or wherein a predefined prediction value is not be constant, or wherein a predefined prediction value is a function of surrounding coefficient values.

11. The method of any of claims 1-10, wherein an actual prediction value is used to code a coefficient value remainder.

12. The method of any of claims 1-11, wherein an accurate prediction P is derived on both an encoder and a decoder side where X=coeff−P at the encoder the decoder decodes X and adds P to obtain a coefficient value, or wherein a prediction derivation process is applied after dependent quantization or RDOQ, or wherein a prediction derivation process is applied with a dependent quantization (DQ) or a RDOQ process, or wherein an approximation of a prediction is used such that an absolute value of a prediction may be limited to C, where C is any positive number, or wherein a binary search style is used to determine a prediction value, or wherein all possible value with absolute values less than C are examined and a value with a lowest cost is used as a prediction.

13. The method of any of claims 1-12, wherein a partial prediction value is used to predict a part of a coefficient.

14. The method of any of claims 1-13, wherein information related to a zero coefficient is not predicted, or wherein remaining coefficients are predicted based on a greater than zero flag, or wherein information related to a coefficient being greater than one is predicted, or wherein remaining coefficients are predicted based on a greater than one flag, or wherein information related to a coefficient being greater than two is predicted, or wherein remaining coefficients are predicted based on a greater than two flag, or wherein any information in second residual coding pass is predicted, or wherein any information in third residual coding pass is predicted, or wherein a part of a coefficient is signaled and another part of the coefficient is predicted, or wherein a partial prediction includes deriving a prediction value from a set of values or actual an prediction for a part of the coefficient.

15. The method of any of claims 1-14, wherein a cost for evaluating a coefficient value hypothesis or prediction is a function of at least one neighboring sample.

16. The method of any of claims 1-15, wherein a cost is calculated as a difference between a partial reconstruction of border samples in a current block and a corresponding reference where the corresponding reference is derived from neighboring block reconstruction, or wherein one or more rows, one or more columns, or both are used as a partial reconstruction area, or wherein K1 rows, K2 columns, or both are used as a partial reconstruction area where K1 and K2 are integer numbers, or wherein different cost functions are used to derive one hypothesis cost, or wherein a cost considers a continuity between a reference template and reconstructed samples neighboring to a current template in addition to a sum of absolute differences SAD.

17. The method of any of claims 1-16, wherein a number of the multiple transform selection (MTS) candidates depends on coefficient characteristics.

18. The method of any of claims 1-17, wherein a number of the MTS candidates depends on a last significant coefficient position, or wherein a number of candidates for a last significant coefficient position between P_i and P_i+1 are K_i where P_i and K_i are any non-negative numbers where K_i<=K_i+1<=. . . , or wherein a number of the MTS candidates and context for coding an index depends on a sum of absolute value of coefficients, or wherein a number of the candidates for sum of absolute value of coefficients between P_i and P_i+1 are K_i where P_i and K_i are any non-negative numbers where K_i<=K_i+1<= . . . , or wherein a sum of absolute value of some, but not all, positions are used for determining a number of the MTS candidates and context for coding an index, or wherein a sum of absolute value of some, but not all, positions (not all) are used for determining a number of MTS candidates and context for coding an index, or wherein a number of the MTS candidates and context for coding an index depends on a sum of partial absolute values of coefficients, or wherein any combination of a partial sum and a full sum depending on a coefficient position or value are used for determining a number of the MTS candidates and context for coding an index, or where a sum of the min (abs(coeff), Ci) is used for determining a number of the MTS candidates and a context for coding an index where Ci is any non-negative integer and is different for each position pi.

19. The method of any of claims 1-18, wherein a minimum function is used to determine a predicted sign such that a prediction of N signs results in a 2\hat{ }N hypothesis that includes going through all the 2\hat{ }N costs and finding a minimum to determine a predicted sign.

20. The method of any of claims 1-19, wherein a hypothesis with a lowest cost among all 2\hat{ }N costs determines a predicted sign for all the N signs, or wherein a hypothesis with a lowest cost among all the 2\hat{ }N costs only determines a predicted sign for a first k signs where k is any integer number of N or less, or wherein after coding to determine whether a prediction of a first k signs is correct, non-correct signs hypothesis are discarded and remaining hypothesis are used for predicting remaining signs.

21. The method of any of claims 1-20, wherein a head-to-head minimum function is used to determine predicted signs.

22. The method of any of claims 1-21, wherein a head-to-head minimum function is defined as: after calculating a cost for a 2\hat{ }N hypothesis for an ith sign, the 2\hat{ }(N-1) hypothesis is related to a negative ith sign, the 2\hat{ }(N-1) hypothesis is related to positive ith sign, and remaining N-1 sign situations are identical and a comparison of these 2\hat{ }(N-1) negative and 2\hat{ }(N-1) positive hypothesis is performed head-to-head to count a number of the times the negative hypothesis and the positive hypothesis have lower costs, or wherein whichever hypothesis has a most head-to-head lower cost is chosen as a predicted sign, or wherein head-to-head minimum functions are applied on all 2\hat{ }N hypothesis for all signs, or wherein after determining an actual sign for an ith sign, incorrect hypothesis are discarded and head-to-head min function is applied on remaining hypothesis, or wherein any combination of discarding or keeping incorrect hypothesis is applied when using hypothesis to determine predicted signs.

23. The method of any of claims 1-22, wherein a combination of different cost definitions is used to determine predicted signs.

24. The method of any of claims 1-23, wherein for signs at positions p1, . . . pJ one cost function is used and for signs at positions q1, . . . qK another cost function is used, or a combination discarding incorrect hypothesis and keeping incorrect hypothesis is used in combination with any combination of different cost functions for each sign prediction, or wherein different cost functions are used for determining a sign prediction for one sign.

25. The method of any of claims 1-24, wherein cost definitions and decision making used for sign prediction are used for coefficient value prediction.

26. The method of any of claims 1-25, wherein a minimum function is used to determine a coefficient value prediction, or wherein a head-to-head minimum function is used to determine a coefficient value prediction, or wherein an incorrect hypothesis is discarded depending on coding side information related to coefficient value prediction, or wherein any combination of discarding incorrect hypothesis or retaining incorrect hypothesis is used in combination with any combination of different cost functions for each sign prediction.

27. The method of any of claims 1-26, wherein any combination of sign prediction and coefficient value prediction for candidates are applied.

28. The method of any of claims 1-27, wherein sign prediction is applied on all coefficients, or wherein sign prediction is applied only on N signs, or wherein a first N signs based on a predefined scan order are used for sign prediction, or wherein a first N signs based on coefficient magnitude are used for the sign prediction, or wherein only signs of coefficient at positions p1, . . . pN are used for sign prediction, or wherein only coefficient at positions q1, . . . qM are used for coefficient value prediction, or wherein sign prediction or coefficient value prediction are applied for a coefficient in a mutually exclusive manner, or wherein sign prediction or coefficient value prediction are both applied for a coefficient, or wherein all of signs are predicted prior to prediction of coefficient values, wherein all of coefficient values are predicted prior to prediction of signs, or wherein any order combination of predicting signs and coefficient values is applied.

29. The method of any of claims 1-28, wherein there are differences between passes used for residual coding.

30. The method of any of claims 1-29, wherein different passes are used depending on a total number of context coded bins, or wherein there is no limitation on a number of context coded bins, or wherein prediction is used for the position of specified values.

31. An apparatus for processing video data comprising: a processor; and a non-transitory memory with instructions thereon, wherein the instructions upon execution by the processor, cause the processor to perform the method of any of claims 1-30.

32. A non-transitory computer readable medium comprising a computer program product for use by a video coding device, the computer program product comprising computer executable instructions stored on the non-transitory computer readable medium such that when executed by a processor cause the video coding device to perform the method of any of claims 1-30.

33. A non-transitory computer-readable recording medium storing a bitstream of a video which is generated by a method performed by a video processing apparatus, wherein the method comprises: determining to predict a value of a residual coefficient based on a cost; and generating a bitstream based on the determining.

34. A method for storing bitstream of a video comprising: determining to predict a value of a residual coefficient based on a cost; generating a bitstream based on the determining; and storing the bitstream in a non-transitory computer-readable recording medium.

35. A method, apparatus or system described in the present document.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing video data, comprising:
determining to predict a value of at least one residual coefficient based on a cost; and
performing a conversion between a video and a bitstream of the video based on the value of the at least one residual coefficient.

2. The method of claim 1, wherein the at least one residual coefficient is used in transform coding or transform-skip coding.

3. The method of claim 1, wherein only a value of a direct current (DC) coefficient is predicted; or
wherein a value of first N coefficient(s) is predicted, wherein N is a positive integer number, and wherein the first N coefficient(s) is determined based on a raster scan order, a diagonal scan order, a vertical scan order, or a horizontal scan order, or based on dividing coefficients into subblocks and based on any combination of a scan order for the subblocks and any scan order for the coefficients inside the subblocks; or
wherein N coefficients at positions p1, p2, . . . pN are predicted, wherein p1, p2, . . . pN are non-negative numbers.

4. The method of claim 1, wherein prediction of a coefficient depends on coding information, and the coding information comprises at least one of: a partial value of a reconstructed coefficient; a parity; surrounding neighboring values; a block size; a prediction mode used for a block, which depends on whether the block is inter coded or intra coded, depends on an intra direction value, or depends on a type of an inter prediction used for the block; multiple transform selection (MTS) index values; Low-Frequency Non-Separable Transform (LFNST) index values; a block partitioning type; a transform skip flag; a quantization parameter (QP); color components, or a color format.

5. The method of claim 1, wherein information related to a value of a coefficient is derived from a cost derivation process;
wherein a full coefficient is derived from the cost derivation process,
wherein a prediction of a coefficient is derived from the cost derivation process and the coefficient is added by the prediction to obtain a final coefficient; or
wherein a scaling factor is derived from the cost derivation process and a coefficient is multiplied or divided by the scaling factor to obtain a final coefficient; or
wherein module T information is derived, and a value of a final coefficient corresponding to a coefficient is T*coeff+t, where T is a positive integer and t is an integer between 0 and T-1, coeff indicates the coefficient, in a case of T=2, and the cost derivation process determines a parity of the coefficient.

6. The method of claim 1, wherein derived information related to a prediction value is from a set of values;
wherein the prediction value is predicted from 0 and C, a value of a final coefficient is X or X+C, where C is an integer, X is a partially coded coefficient, or
wherein the prediction value is not signaled, depending on predicting to 0 or C, a value of a final coefficient is X or X+C, where C is an integer, X is a partially coded coefficient, or
wherein a flag is coded to indicate whether the predication value of 0 or C is correct or not, when the prediction value of 0 is incorrect, an opposite value of C is added to X, and when the prediction value of C is incorrect, an opposite value of 0 is added to X, or
wherein two or more prediction values are included in one set, or
wherein each set of N sets of values includes M_i candidates, for i from 1 to N, and the N sets are implicitly derived based on surrounding information or signaled explicitly, wherein N is a positive integer, and M_i is a positive integer, or
wherein a best prediction value of M possible prediction value(s) is added to X to create a final coefficient of X+vK, without any signaling, wherein X is a partially coded coefficient, M is a positive integer, vK denotes the best prediction value, 1<=K<=M, or
wherein all M possible prediction value(s) is sorted based on a predefined cost and an index is signaled to indicate a correct prediction value, M is a positive integer, or
wherein a prediction derivation process is applied after dependent quantization and/or rate distortion optimization quantization (RDOQ) is complete or simultaneously with a process of the dependent quantization and/or a process of the RDOQ, or
wherein predefined prediction values are not constant, or
wherein a predefined prediction value is a function of surrounding coefficient values, or
wherein a function of a summation of absolute values of T surrounding neighbors determines predefined prediction values, or
wherein a function of a summation of partial absolute values of T surrounding neighbors determines predefined prediction values.

7. The method of claim 1, wherein an actual prediction value is used to code a coefficient value remainder;
wherein an accurate prediction denoted by P is derived on both an encoder side and a decoder side, wherein X=coeff−P is coded at the encoder side, the X is decoded at the decoder side and is added with P to obtain a final coefficient value, or
wherein a prediction derivation process is applied after dependent quantization and/or rate distortion optimization quantization (RDOQ) is complete, or wherein a prediction derivation process is applied with a dependent quantization (DQ) and/or RDOQ process, or
wherein an approximation of a prediction is used, an absolute value of the prediction is limited to C, where C is a positive number, a parity of the prediction is always even, always odd, or derived from a partial coefficient value, or
wherein a binary search style method is used to determine a prediction value, or
wherein all possible values with absolute values less than C are examined and a value with a lowest cost is used as a prediction, where C is a positive number.

8. The method of claim 1, wherein a partial prediction value is used to predict a part of a coefficient; or
wherein information related to being 0 or not is predicted, or
wherein remaining coefficients are predicted after signaling a greater than 0 flag, or
wherein information related to being greater than 1 or not is predicted, or
wherein remaining coefficients are predicted after signaling a greater than 1 flag, or
wherein information related to a greater than 2 flag or not is predicted, or
wherein remaining coefficients are predicted after signaling a greater than 2 flag, or
wherein any information in second pass of residual coding is predicted, or
wherein any information in third pass of residual coding is predicted, or
wherein a part of a coefficient is signaled and another part of the coefficient is predicted, or
wherein a partial prediction has a form deriving a prediction value from a set of values, or an actual prediction for a part of the coefficient.

9. The method of claim 1, wherein a cost for evaluating a coefficient value hypothesis or prediction is a function of at least one neighboring sample, or
wherein a cost is calculated as a difference between a partial reconstruction of border samples in a current block and a corresponding reference, the corresponding reference is derived from neighboring block reconstruction, the partial reconstruction of the border samples and the corresponding reference are adjacent or the partial reconstruction of the border samples and the corresponding reference have a same number of samples, each reconstructed border sample has a corresponding reference sample, and a difference is calculated by comparing each pair of corresponding reconstructed border sample and reference sample, or
wherein one or more rows, one or more columns, or both the one or more rows and the one or more columns are used as a partial reconstruction area, or
wherein different cost functions are used to derive one hypothesis cost, the hypothesis cost is: a sum of absolute difference (SAD) between partial reconstruction and references of the partial reconstruction, a sum of absolute transformed difference (SATD) or other cost measure between the partial reconstruction and the references of the partial reconstruction, a mean removal (MR) based SAD (MR-SAD) between template samples and references of the template samples, or a weighted average of SAD or MR-SAD and SATD between the partial reconstruction and the references of the partial reconstruction, or
wherein a cost function between partial reconstruction and reference template is: SAD, MR-SAD, SATD, MR-SATD, sum of squared differences (SSD), MR-SSD, sum of square errors (SSE), MR-SSE, weighted SAD, weighted MR-SAD, weighted SATD, weighted MR-SATD, weighted SSD, weighted MR-SSD, weighted SSE, weighted MR-SSE, or gradient information, or
wherein a cost considers a continuity (Boundary_SAD) between a reference template and reconstructed samples adjacently or non-adjacently neighboring to a current template in addition to a SAD, wherein reconstructed samples left and/or above adjacently or non-adjacently neighboring to the current template are considered, or
wherein a cost is calculated based on SAD and Boundary_SAD, or wherein a cost is calculated as (SAD+w*Boundary_SAD), where w is pre-defined, signaled, or derived according to decoded information.

10. The method of claim 1, wherein a number of multiple transform selection (MTS) candidates depends on coefficient characteristics and/or a last significant coefficient position, or
wherein a number of candidates for a last significant coefficient position between P_i and P_i+1 is K_i, where P_i and K_i are non-negative numbers, or
wherein a number of MTS candidates and context for coding an index depend on a sum of absolute value of coefficients, or
wherein a number of candidates for a sum of absolute values of coefficients between P_i and P_i+1 is K_i, where P_i and K_i are non-negative numbers, or
wherein a sum of absolute values of some, but not all, positions is used for determining a number of MTS candidates and context for coding an index, wherein a DC position is not used in the sum, wherein only coefficients at positions p1, p2, . . . pN are used for the sum of the absolute values, where each of p1, p2, . . . pN is a non-negative integer, or
wherein a number of MTS candidates and context for coding an index depends on a sum of partial absolute values of coefficients, wherein a partial sum is min (abs(coeff), C), where C is a non-negative number, or
wherein any combination of a partial sum, and a full sum depending on a coefficient position and/or value is used for determining a number of MTS candidates and/or a context for coding an index, or
wherein a sum of the min (abs(coeff), Ci) is used for determining a number of MTS candidates and/or a context for coding an index, where Ci is a non-negative integer and is different for each position pi, pi is a non-negative integer, wherein a coefficient value at the position pi is not used in a case of Ci=0 or a coefficient value at the position pi is fully used in a case of Ci=MAX_INT, or
wherein any function other than “min” is used.

11. The method of claim 1, wherein a minimum function is used to determine a predicted sign, prediction of N signs results in 2\hat{ }N hypothesis, the predicted sign is determined by going through all 2\hat{ }N costs and finding a minimum, where N is a positive integer; or
wherein a hypothesis with a lowest cost among all 2\hat{ }N costs determines a predicted sign for all N signs, and/or wherein a hypothesis with a lowest cost among all 2\hat{ }N costs only determines a predicted sign for first k sign(s), where k is an integer less than or equal to N, or
wherein after coding to determine whether prediction of first k sign(s) is correct, hypothesis of non-correct signs is discarded and remaining hypothesis is used for predicting remaining signs.

12. The method of claim 1, wherein a head-to-head minimum function is used to determine predicted signs; or
wherein a head-to-head minimum function is defined as: after calculating a cost for 2\hat{ }N hypothesis, for an i-th sign, 2\hat{ }(N-1) hypothesis is related to a negative i-th sign, 2\hat{ }(N-1) hypothesis is related to a positive i-th sign, and remaining N-1 sign situations are identical, and 2\hat{ }(N-1) negative hypothesis and 2\hat{ }(N-1) positive hypothesis are compared head-to-head to count a number of times the negative hypothesis or the positive hypothesis having a lower cost, or
wherein whichever hypothesis has a most head-to-head lower cost is chosen as a predicted sign, or
wherein a head-to-head minimum function is applied on all 2\hat{ }N hypothesis for all signs, or
wherein after determining an actual sign for an i-th sign, incorrect hypothesis is discarded and the head-to-head minimum function is applied on remaining hypothesis, or
wherein any combination of discarding or keeping incorrect hypothesis is used to determine predicted signs.

13. The method of claim 1, wherein a combination of different cost definitions is used to determine predicted signs;
wherein for signs at positions p1, . . . pJ, one cost function is used, and for signs at positions q1, . . . qK, another cost function is used, wherein p1, . . . , pJ and q1, . . . , qK are integer numbers between 1 and N and no two of p1, . . . , pJ and q1, . . . , qK are the same, or wherein the one cost function uses a minimum function and the another cost function uses a head-to-head minimum function, or the one cost function uses a head-to-head minimum function and the another cost function uses a minimum function, or
wherein a combination discarding incorrect hypothesis or keeping incorrect hypothesis is used in combination with any combination of different cost functions for each sign prediction, or
wherein different cost functions are used for determining sign prediction for one sign, or
wherein when based on one cost criteria positive hypothesis and negative hypothesis costs are smaller than a predefined threshold or bigger than a predefined threshold, a next cost function is used to determine which sign is predicted, continuously until a last cost function in a queue or until threshold criteria for that function are satisfied, or
wherein a cost is defined based on a weighted cost difference between head-to-head hypotheses, or
wherein instead of just comparing Positive hypothesis to Negative hypothesis and adding 1 or 0 to each camp, w1 and w2 are added to each camp, where each of w1 and w2 is a real number.

14. The method of claim 1, wherein cost definitions and decision making used for sign prediction are used for coefficient value prediction; or
wherein a minimum function is used to determine a coefficient value prediction, or
wherein a head-to-head minimum function is used to determine a coefficient value prediction, or
wherein a wrong hypothesis is discarded depending on coding side information related to coefficient value prediction, or
wherein any combination of discarding wrong hypothesis or keeping wrong hypothesis is used in combination with any combination of different cost functions for each sign prediction.

15. The method of claim 1, wherein any combination of sign prediction and coefficient value prediction for candidates is applied;
wherein sign prediction is applied on all coefficients, or
wherein sign prediction is applied only on N signs, or
wherein first N signs based on a predefined scan order are used for sign prediction, or
wherein first N signs based on coefficient magnitude are used for sign prediction, or
wherein only signs of coefficients at positions p1, . . . , pN are used for sign prediction, or
wherein only coefficients at positions q1, . . . , qM are used for coefficient value prediction, or
wherein sign prediction or coefficient value prediction is applied for a coefficient in a mutually exclusive manner, or
wherein sign prediction and coefficient value prediction are both applied for a coefficient, or
wherein all of signs are predicted prior to prediction of coefficient values, or
wherein all of coefficient values are predicted prior to prediction of signs, or
wherein any order combination of predicting signs and coefficient values is applied.

16. The method of claim 1, wherein there are differences between passes used for residual coding; or
wherein different passes depending on a total number of context coded bins are used, or
wherein there is no limitation on a number of context coded bins, there are not different passes depending on a total number of context coded bins used, or
wherein prediction is used for a position of 0 or any other value, or
wherein no special treatment is used for a position of 0 or any other value;
wherein usage of the method is dependent on coded information, the coded information includes block sizes, temporal layers, slice types, picture types, and/or color component;
wherein usage of the method is indicated in the bitstream, and wherein an indication of enabling, an indication of disabling, or an indication of which method is applied is signaled at a sequence level, a group of pictures level, a picture level, a slice level, a tile group level, a sequence header, a picture header, a sequence parameter set (SPS), a video parameter set (VPS), a decoding parameter set (DPS), decoding capability information (DCI), a picture parameter set (PPS), an adaptation parameter set (APS), a slice header, a tile group header, a prediction block (PB), a transform block (TB), a coding block (CB), a picture unit (PU), a transform unit (TU), a coding unit (CU), a virtual pipeline data unit (VPDU), a coding tree unit (CTU), a CTU row, a slice, a tile, a sub-picture, and/or other kinds of region containing more than one sample or pixel.

17. The method of claim 1, wherein the conversion includes encoding the video into the bitstream.

18. The method of claim 1, wherein the conversion includes decoding the video from the bitstream.

19. An apparatus for processing video data comprising a processor and a non-transitory memory with instructions thereon, wherein the instructions upon execution by the processor, cause the processor to:
determine to predict a value of at least one residual coefficient based on a cost; and
perform a conversion between a video and a bitstream of the video based on the value of the at least one residual coefficient.

20. A non-transitory computer-readable recording medium storing a bitstream of a video which is generated by a method performed by a video processing apparatus, wherein the method comprises:
determining to predict a value of at least one residual coefficient based on a cost; and
generating the bitstream based on the value of the at least one residual coefficient.
